(19) United States
(12) Patent Application Publication
(10) Pub. No.: US 2005/0187925 A1
(43) Pub. Date: Aug. 25, 2005

(54) Schechinger/Fennell System and method for filtering data search results by utilizing user selected checkboxes"

(76) Inventors: Diane Schechinger, Half Moon Bay, CA (US); David Fennell, Redwood City, CA (US)

Correspondence Address: Diane Schechinger, 441 Alameda Avenue, Half Moon Bay, CA, 94019, US

(21) Appl. No.: 11/062,340

(22) Filed: Feb. 22, 2005

Related U.S. Application Data
(60) Provisional application No. 60/547,177, filed on Feb. 25, 2004.
(60) Provisional application No. 60/578,332, filed on Jun. 10, 2004.
(60) Provisional application No. 60/578,357, filed on Jun. 10, 2004.

(51) Int. Cl. G06F 17/30

(52) U.S. Cl. 707/3

(57) ABSTRACT

The use of computer technology and the internet to quickly locate, view, compare by user-selected preferences, and select marketable products or other data. The growth of the internet has exceeded the capacity of existing technologies and business methods to allow business and consumer users to sort through a vast sea of data. Checkboxes associated with displayed products enable the manipulation of data according to user-selected criteria, in which all conceivable products, whatever their use or country of manufacture, can be located, reviewed, compared, and selected for purchase. The invention uses a hierarchy-based software system that will allow the computer user to search and find required data directly. The user will no longer waste time sifting through search results that are outside the needs of his current search.

### II. CROSS-REFERENCE TO RELATED APPLICATIONS

A. World.info PPA #5, “Schechinger/Fennell System and Method for filtering Data Search by Utilizing User Selected Checkboxes, filed Feb. 25, 2004, PTO Appl. No. 60/547,177 Note: This is the PPA for the present RPA.)
B. World.info PPA #1, “Schechinger/Fennell System and Method for Categorization of Data,” filed Jul. 14, 2003, PTO Appl. No. 60/487,395
C. World.info RPA #1, “Fennell Hierarchy for Marketable Product Categorization,” filed Jul. 12, 2004, PTO appl. Ser. No. 10/889,374. (This is the RPA for PPA Appl. No. 60/487,395 above. Note change in Title wording.)
D. World.info PPA #2, “Schechinger/Fennell System and Method for Data Display Using Variable Field Headings,” filed Jan. 16, 2004, PTO Appl. No. 60/536,805.
E. World.info RPA #2, “System and Method for Data Display Using Variable Field Names,” filed (mailed) Jan. 10, 2005.
F. World.info PPA #3, “Schechinger/Fennell System and Method for Organization and Display of Data and Identification of Key Data for Comparison and Analysis,” filed Jan. 16, 2004, PTO Appl. No. 60/536
G. World.info RPA #3, “Schechinger/Fennell System and Method for Organization and Display of Data and Identification of Key Data for Comparison and Analysis,” filed (mailed) Jan. 10, 2005
H. World.info PPA #4, “Schechinger/Fennell System and Method for Filtering Search Results by Utilizing User-Selected Parametric Values from a Self-Defined Drop-Down List on a Website,” filed (mailed) Feb. 18, 2004, no PTO # on file
I. World.info RPA #4, “Schechinger/Fennell System and Method for Filtering Search Results by Utilizing User-Selected Parametric Values from a Self-Defined Drop-Down List on a Website,” filed (mailed) Feb. 18, 2005, no PTO # on file
J. World.info PPA #6, “Schechinger/Fennell/Hirzel System and Method for Associating Unlimited Numbers of Parametric Names and Values to a Specific Product and the Ability to Select or Deselect for Viewing the Results on a Parametric Display Page,” filed Jun. 10, 2004, PTP Appl. No. 60/578,332
K. World.info PPA #7, “Schechinger/Fennell System and Method for Finding Specific Products that Meet Exact User Defined Requirements in Three Clicks.” Filed Jun. 10, 2004, PTO Appl. No. 60/578,357

### III. BACKGROUND OF THE INVENTION—FIELD OF THE INVENTION

This invention relates to, but is not limited to, the use of computer database and software technology and the internet to locate, view, compare, and select marketable products or other data.

### IV. BACKGROUND OF THE INVENTION—PRIOR ART

There is a great need in business, research and a host of other areas to be able to find the exact product, meeting the exact specifications needed, without having to tediously eliminate and sort through unrelated products or items. Computer database technology is commonly used to search for important information for business, purchasing, education and numerous other applications.

The growth of the internet has exceeded the capacity of existing technologies and business methods to allow business and consumer users to access, compare, and sort items of a like kind in a comprehensible manner from this vast ocean of unorganized data. Current product searches over the internet provide the user with lots of results with no effective way to filter them for his specific needs. To use a familiar analogy, the user is confronted with a bowl of mixed fruit, but he needs to be able to compare “apples to apples, and oranges to oranges.” The present invention, working in combination with our hierarchy, variable parameter heading and variable parameter values (patents pending), enables the user to quickly filter the results of his search to only those products which, upon his review, meet his specific requirements. The user knows exactly what he is looking for, but current website display processes do not permit him to search by his own unique requirements. There is no one universally adaptable system by which data of any kind whatsoever, whether or not commercially useful, can be made available for “apples-to-apples” search by combination of attribute values.

Existing methods of filtering information from computer databases, commonly known as “search engines,” which can be found in websites such as “Google.com,” “Vehix.com,” “Globalspec.com,” and others, are either too nonspecific, or too restrictive in their approach, and do nothing meaningful to organize the countless reams of marketing data into an instantly usable and understandable format. Pages and navigation systems are typically unique to each website. Typically the data available on a given website is commercially-driven, and restricted to one company, or the few who have paid for display in that website. Consequently the data available does not represent all existing product types, but only that associated with those who have paid for the privilege of display at a given site.

The current technology for displaying of information utilizes complex verbiage often with only one item described per internet page or in a scrolling multiple page like fashion. There are no mechanisms by which users can search through lists of products and select according to combinations of attributes, which may for any given product run into the thousands or millions of possible combinations, in order to find those few products of that type which possess those desired attributes. There is no universally available system of identifying and displaying potentially infinite numbers of products in a way in which “apples-to-apples” comparisons of similar product parameters or attributes can be reviewed in an easy-to-use spreadsheet type of format. The user must read vast quantities of information on vast numbers of products to be able to compare the parameters of interest, often to only find that all of the parameters of his interest are not even listed with some of the products.

Using the current art, once the user has entered an existing site, he is obliged to navigate, using the familiar “point-and-click” process, through a varying number of discrete steps, from the website's home page, through that site's unique system of organization. The user's interaction with the website is restricted to navigation, his ability to manipulate data to his own needs limited or nonexistent. Eventually, he may find that product whose combination of features and attributes meets his needs, most frequently in a multitude of clicks. The user often gets lost in the complex site navigation unique to each website, having never found the products of interest. It is at best a laborious, inefficient process, yielding doubtful results. As the use of computer data and the internet continues to grow, the problem of finding desired information will grow.

We have invented a system and method of identifying and selecting from among potentially infinite numbers of products displayed with their associated attributes in a way in which “apples-to-apples” comparisons can be made within an easy-to-use spreadsheet type of format.

### V. BACKGROUND OF THE INVENTION—OBJECTS AND ADVANTAGES

Accordingly, several objects and advantages of our invention are
A. It creates a system and method of identifying and selecting potentially infinite numbers of attribute values in a way in which “apples-to-apples” comparisons of similar product parameters or attribute values can be seen for contrast and comparison in an easy to use spreadsheet type of format.
B. It creates a spreadsheet display format in which an unlimited number of product types with their associated attribute values can be similarly displayed. The practical result of this universally adaptable display is that the user, having once visited the site to research one product type, will become familiar with the search and display layout for use with any other product type. One navigation system serves all products and all users with equal ease and adaptability.
C. The use of software technology enables the User to select by using checkboxes from an unlimited list any number of only those items which are of interest to him. Selection of any item or item from the list displayed on any of an unlimited number of related pages will reserve the data for that item for display in the refined search. In this way the user can locate from among all the products available in the database only those few which are of particular interest to him.
D. A key feature of the present invention is the use of related page layouts for the display of key specifications. The display may consist of as many related pages or as many tabs (one for each subsequent page) as may be required. Consequently there is no limit to the number of items, or the number of parameters by which they can be compared and selected.
E. Selection or deselection of any item on any page selects or deselects that item for all pages, without disturbing the data on display until after the search has been refined to the selected or deselected products.
F. Items may be selected or deselected from any location on any page of the layout any number of times. The Refine Search button appears on all pages, and refines the search to those products that have been selected by checkbox on any page.
G. The user can expand the refined search by clicking the Show All button, and refine his search again using the checkboxes, an unlimited number of times.
H. This checkbox selection can be used alone or in conjunction with other types of selection, including those covered by patent applications referenced in II-H and II-I above and others yet to be submitted.
I. Although the term product type as used in the present application, the use of the drop-down list as described here is not limited to commercial enterprise. It can be applied to any item, idea, venue, performance, or information of any kind which may lend itself to this type of display. This search-and-display mechanism is universally adaptable to any product type or any other commercial or non-commercial use.
J. Because the products displayed and their associated values are a variable associated with products of same kind (apples to apples), products of interest can be user-selected and the values for those for those specific parameters displayed.
K. The work of seeking out specific products based on a comparison of key specifications, for purchase by purchasing agents, engineers, and designers, and others is thereby rendered more efficient.
L. All products from all vendors are similarly displayed. reducing or eliminating the need for blanket advertising. This allows small business enterprise to compete on an equal footing with large corporations, encouraging innovation throughout the marketplace.
M. The checkbox selection of the present application, as a component of the key parameter display used in conjunction with the Fennell Hierarchy, benefits both ends of the commercial spectrum. It (a) enables the buyer (user) to refine his search to satisfy his owns specific needs, and (b) enables the seller to have his product easily found and readily available to the user's search.
N. The checkbox selection as described is adaptable to other software-based search mechanisms existing and yet to be developed.
O. The system can be used over the internet and will be accessible to end-users who have computers with internet access. Because software enabling the website and the drop-down lists of the present inventions exist at the Web server, installation of software at computer terminals will not be required,
P. The system may also be used privately, within local area networks, for the comparison of privately held or confidential information. with the enabling software installed in the local server.
Q. Further objects and advantages of the invention will become apparent from a consideration of the Figures and ensuing description,

### VI. SUMMARY OF THE INVENTION

### Checkbox Selection of Products on a Website

The invention makes use of computer technology and the internet to quickly locate, view, compare user-selected products from among an unlimited number of products of like kind. The use of software technology enables the display of selected products to be associated an unlimited number of related single-page display layouts, instead of the unrelated single-page displays as used in the current art. This allows a search and display mechanism which is universally adaptable to any product type or any other commercial or non-commercial use. Within this easily comprehensible display the User can easily find, compare, and select from items of like kind and like nature and usage according to combinations of attribute values of interest to the User. Since all products are similarly displayed in a common format with which the user is quickly familiar, and product review and purchase is greatly facilitated, to the mutual advantage of the user and the seller or manufacturer.

The growth of the internet has exceeded the capacity of existing technologies and business methods to allow business and consumer users to sort through a vast sea of data. Checkbox selection of products displayed within fields of key parameters enables the manipulation of data according to user-selected criteria, in which all conceivable products, whatever their use or country of manufacture, can be located, reviewed, compared, and selected for purchase. The user will no longer waste time sifting through search results that are outside the needs of his current search.

### VII. FIGURES

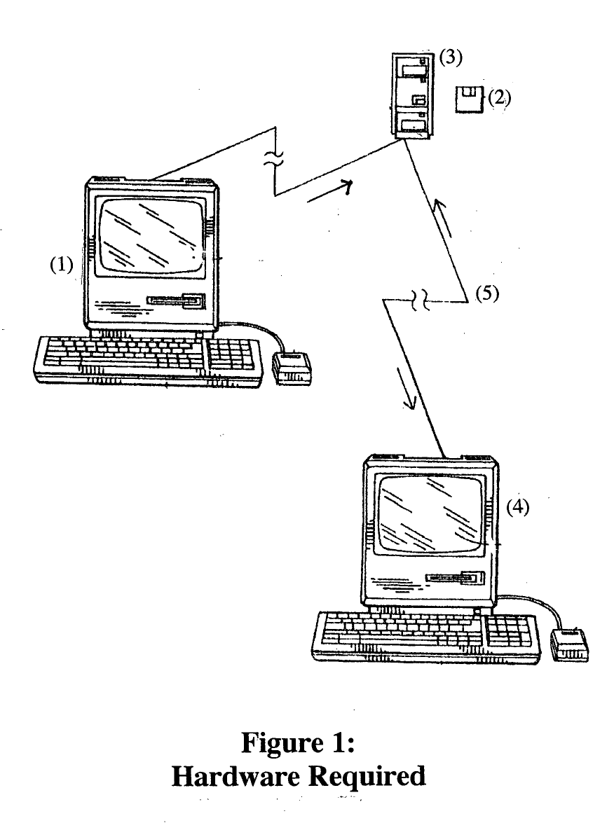

A. FIG. 1: Hardware Required

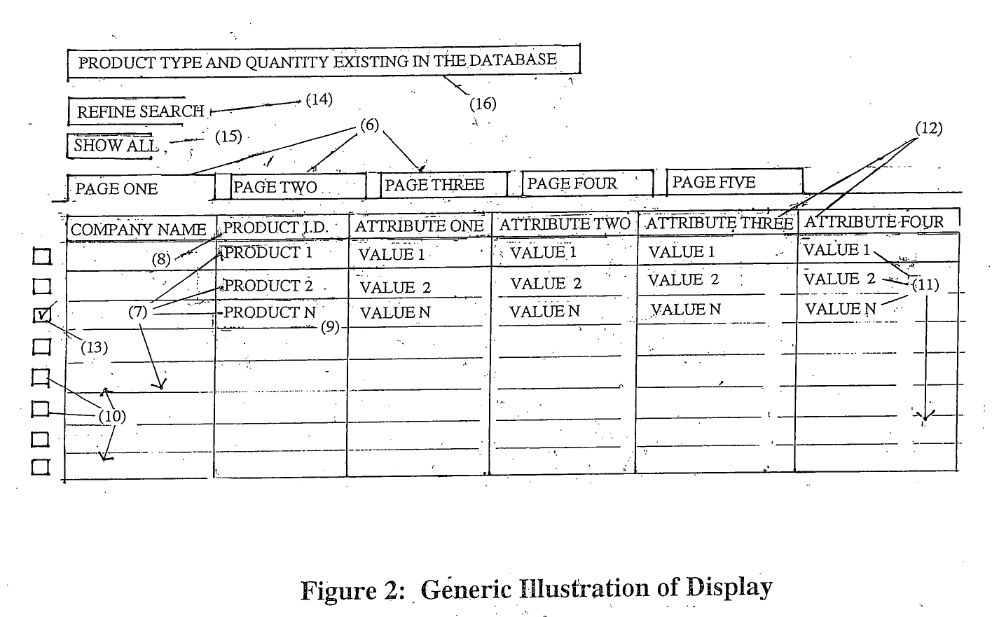

B. FIG. 2: Generic Illustration of Display

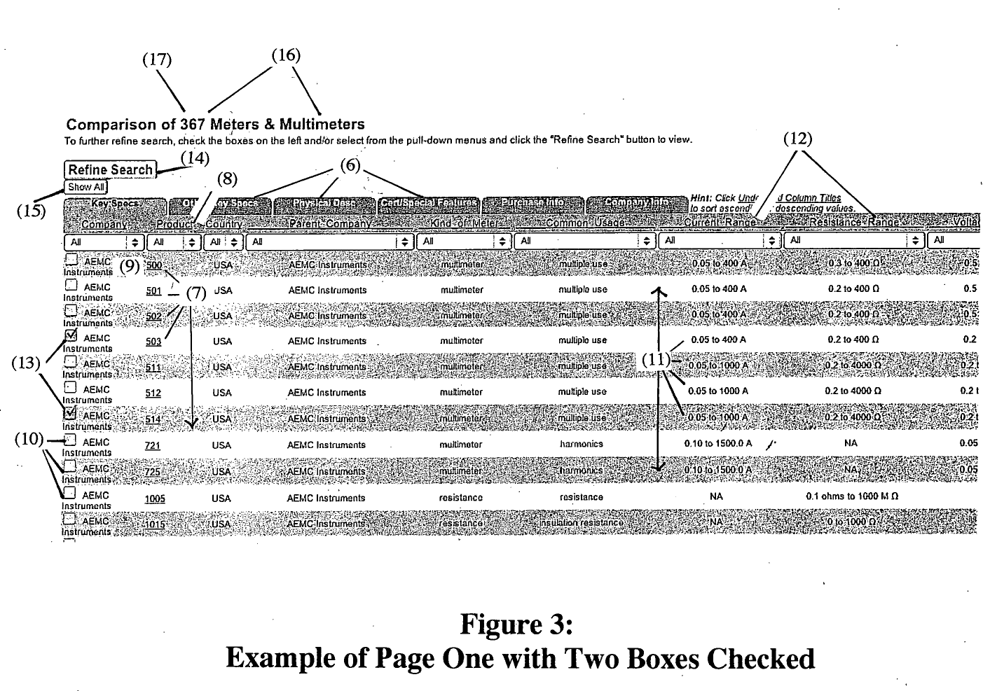

C. FIG. 3: Example of Page One with Two Boxes Checked

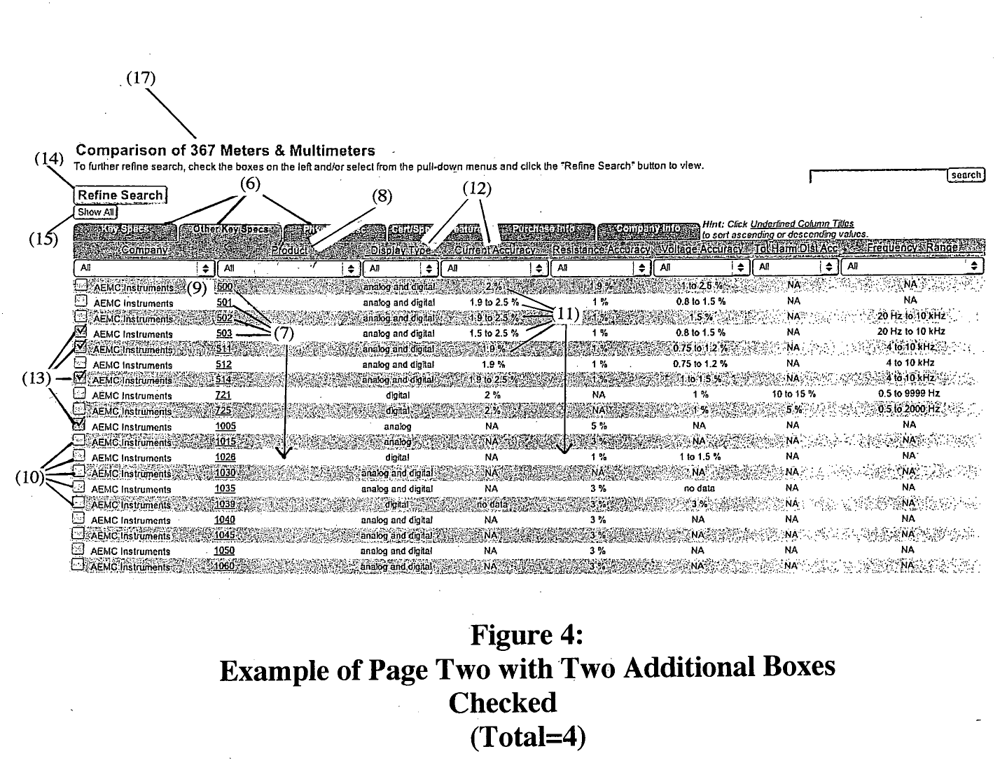

D. FIG. 4: Example of Page Two with Two Additional Boxes Checked (Total=4)

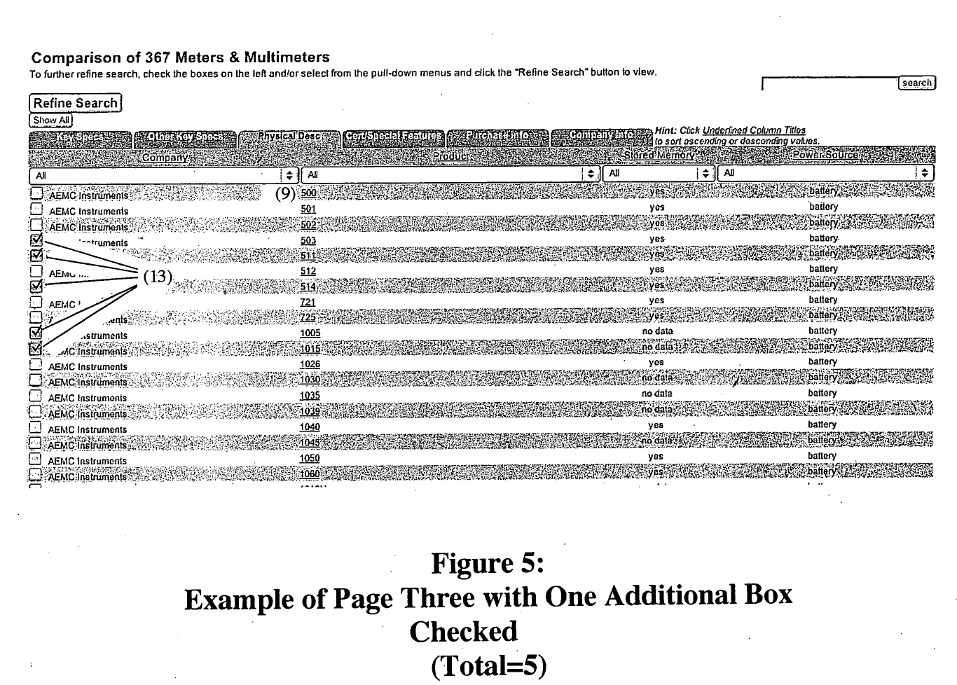

E. FIG. 5: Example of Page Three with One Additional Box Checked (Total=5)

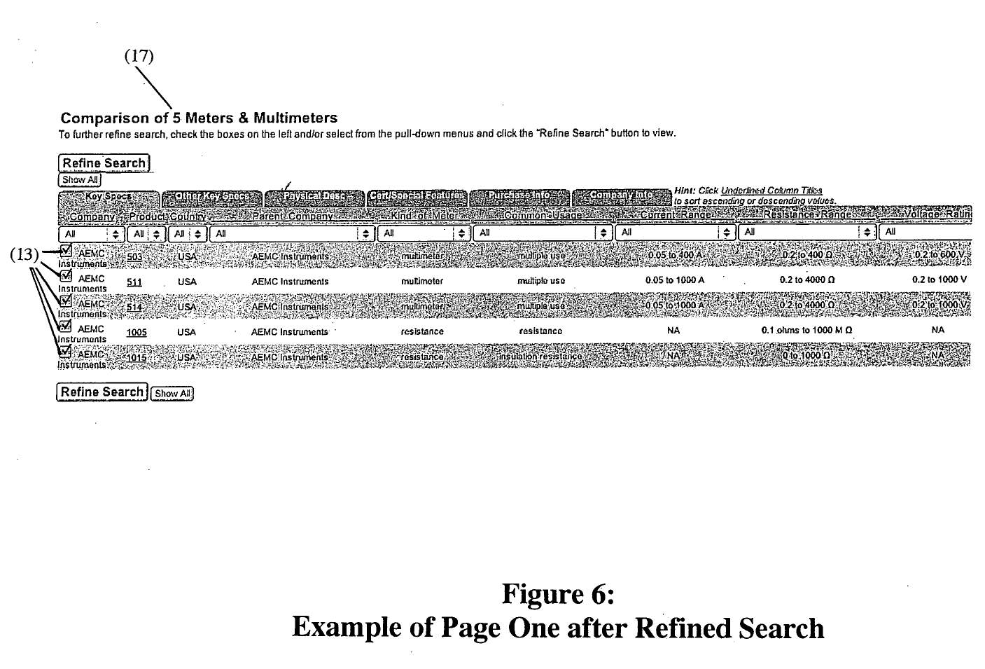

F. FIG. 6: Example of Page One after Refined Search

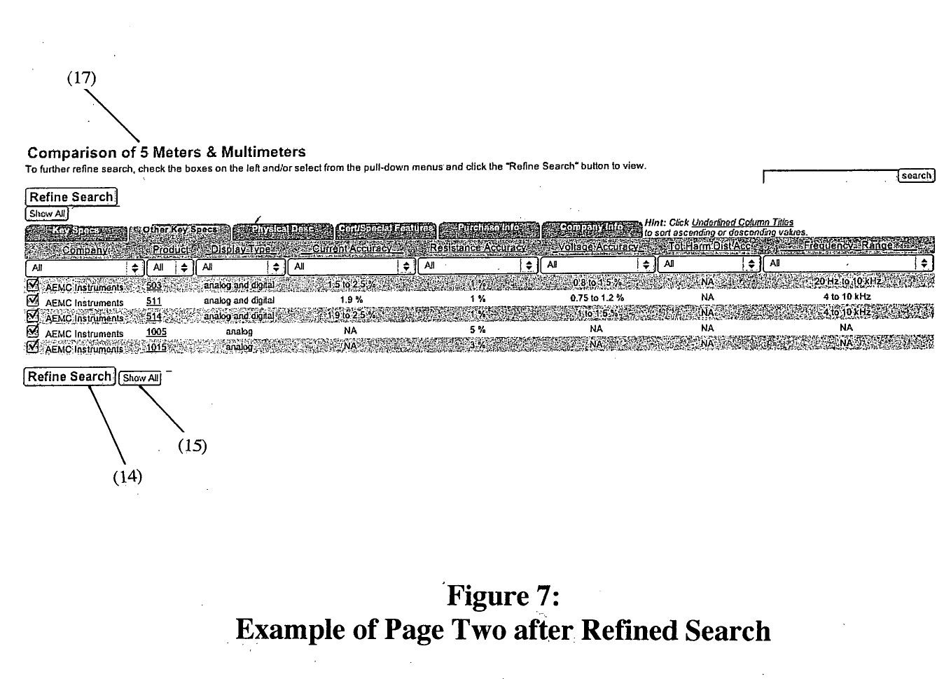

G. FIG. 7: Example of Page Two after Refined Search

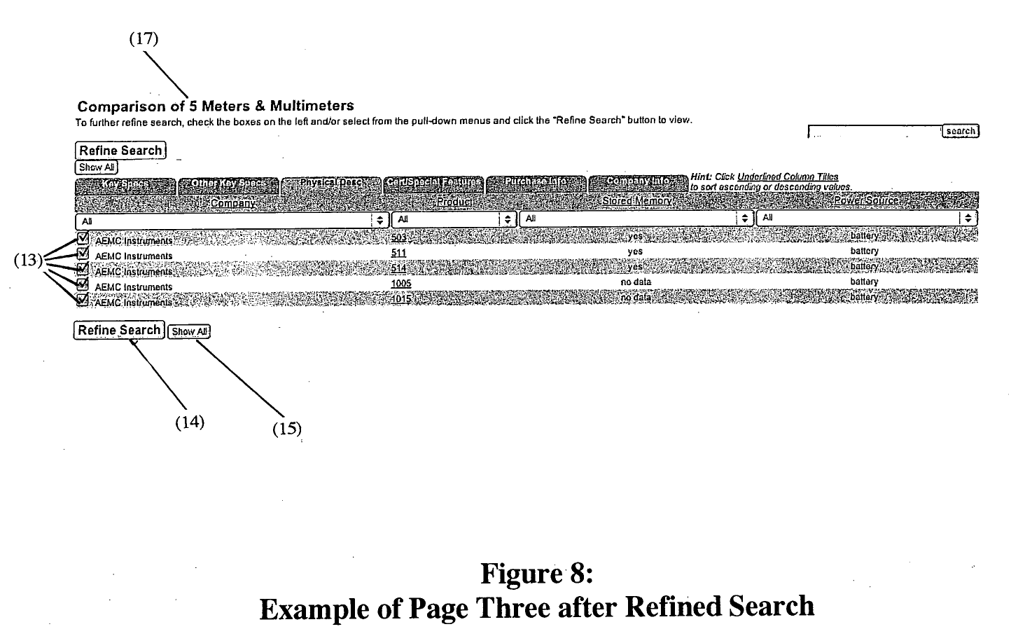

H. FIG. 8: Example of Page Three after Refined Search

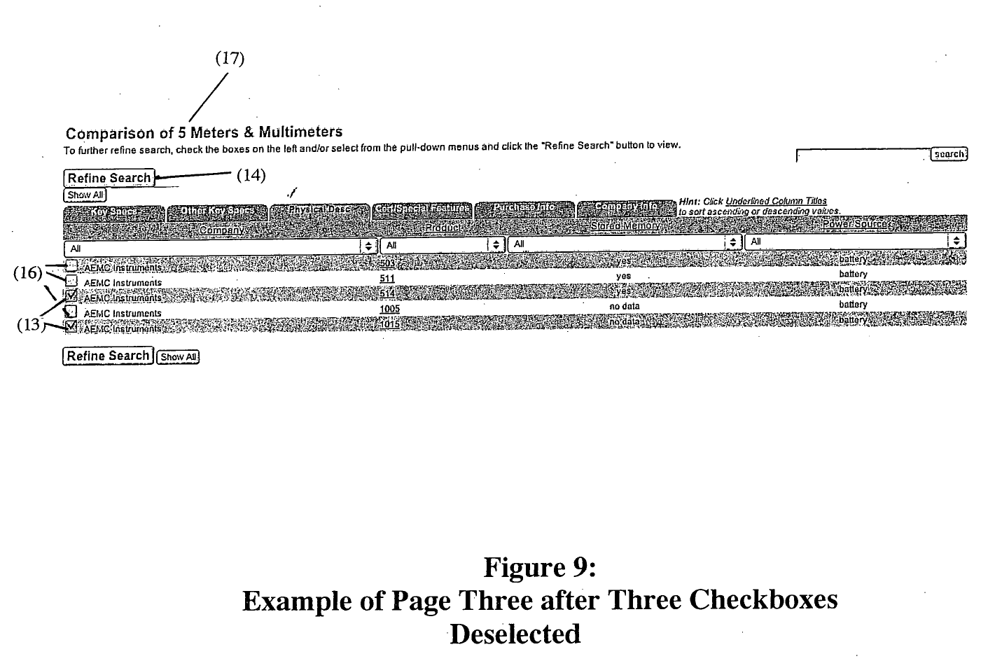

I. FIG. 9: Example of Page Three after Three Checkboxes Deselected

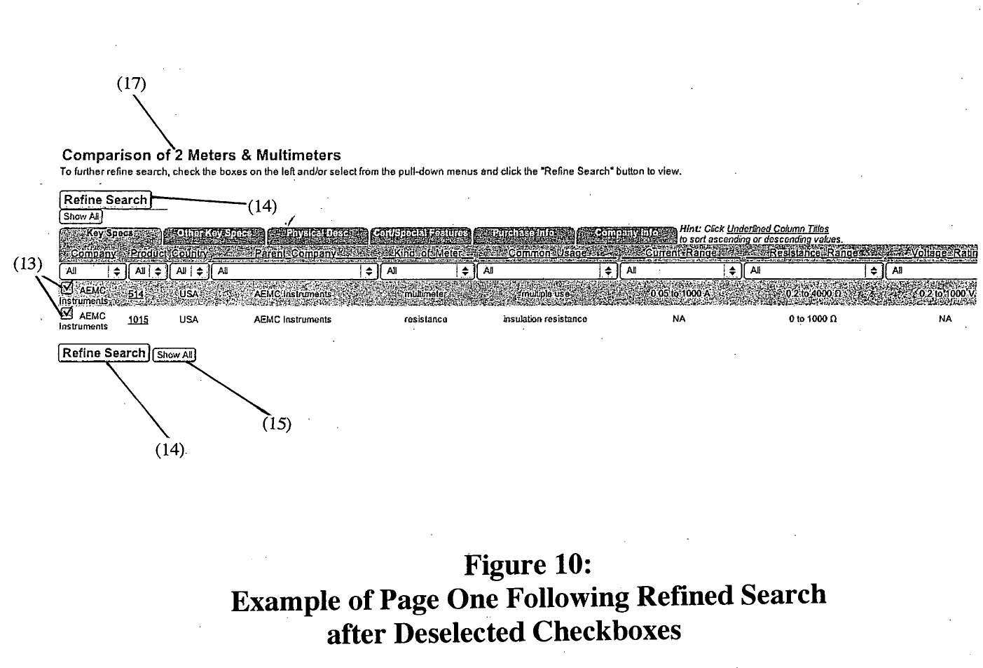

J. FIG. 10: Example of Page One Following Refined Search after Deselected Checkboxes

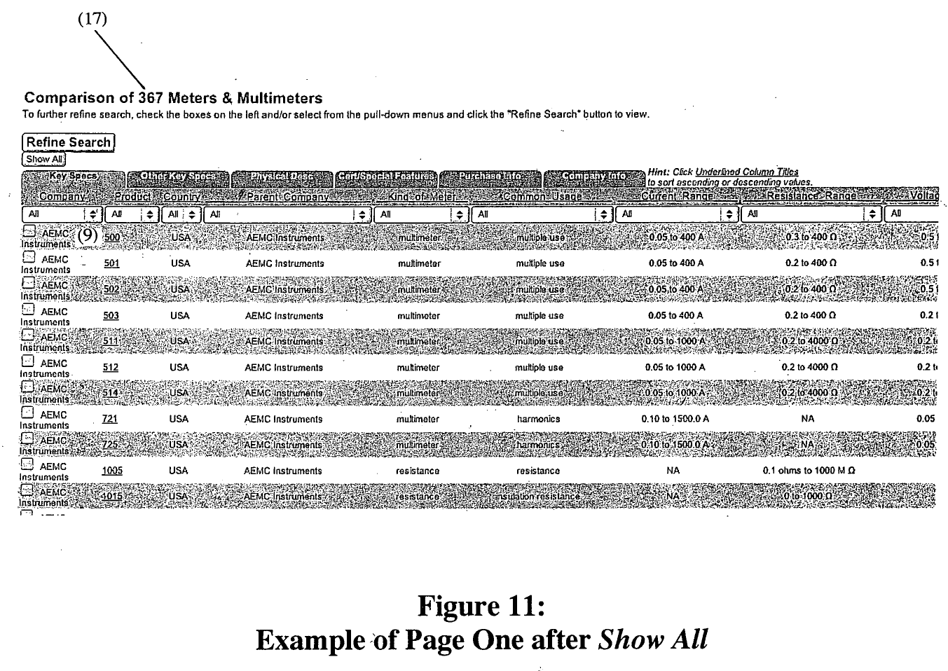

K. FIG. 11: Example of Page On after Show All

### VIII. DETAILED DESCRIPTION

In its preferred embodiment the invention makes use of computer technology and the internet to enable the user to quickly locate, view, and compare marketable products or other data by displayed attribute values associated with those products. Given the opportunity to review products and their associated values in an easily comprehensible spreadsheet display, the user then, by means of checkboxes, selects any number of products for further review. The data is created either manually or automatically at a computer terminal (FIG. 1) (1) and entered from a remote location into a database within a software program (2) installed at the server (3). The hardware equipment required consists of a computer terminal for user access (4), internet access (5) by which the user's computer is linked to a server, and the server itself (3). Software (2) enabling the creation and manipulation of the database is installed at the server. No software is required at the user terminal.

The enabling software for the inventions referenced above (PPAs and RPAs listed in Section II above) creates a format by which all conceivable products, whatever their use or country of manufacture, can be displayed on one common layout. In this universally adaptable layout all products can be compared and contrasted with other products of a like kind, according to various parameters of interest to the user. These inventions claim a method of organizing and displaying data using variable fields in which one layout can be easily and endlessly modified according to preferences established in the program or by the end-user. This is accomplished by the use of our variable field naming (IID and IIE above) and the use of variable parameter fields (IIF and IIG above), in which the product data is entered and displayed for comparison in one layout which can be used in an infinite number of ways. The present patent application, in its preferred embodiment, extends that idea to include the drop-down list display of associated values existing in these variable parameter fields in the following manner.

The user, having navigated in two easy clicks the sequential pages of the World.info database and website (© World.info 2004; PPAs and RPAs relating to organization, search, and display methods referenced in II above and other patent applications yet to be submitted), arrives at the display page listing all products existing in the database as examples of the type (16). The display consists of one or more pages (FIGS. 3, 4, 5) which are simultaneously in view by means of tabs (6) at the top of the display. Using these tabs he selects any page or pages which offer fields of attribute values of particular interest to him.

In the preferred embodiment, the spreadsheet display appears on the user's computer screen in the form of a matrix (FIG. 2). The initial page of the matrix may be one of several, in which all the individual products existing in the database for a given type are displayed in a vertical list at the left of the page (7), beneath the field column heading “Product”(8). The products are listed by the manufacturer's identifying name or number for the product. Each product will appear in the same relative location in similar lists at the left of each of the succeeding pages of the layout (9). In other words, the product at the top of this list on any page will be at the top of the list on all succeeding pages, the second product down will appear as the second product down on all succeeding pages, and so on.

Adjacent to the identifying name for each product appearing at the left of the page appears a checkbox (10) of familiar appearance and usage. This is the checkbox of the present invention, by which any product, or any number of products may be selected or deselected from the list of all products for the type.

Attributes of various kinds will appear in vertical lists of attributes, each in a columnar field dedicated to a single attribute (11), and beneath a similar field heading with the name of each attribute (12). Within each attribute field will appear a value for that attribute associated with the unique product horizontally aligned to the left.

Thus each product may be viewed as a combination of attribute values, all of which will be aligned and visible in a horizontal row associated with each product, and in the same relative location in each succeeding page. Each product for the type may have its own unique combination of attribute values, all of which may be viewed by the user by looking at the succeeding pages. It is by a comparison of these attribute values, displayed in a consistent and instantly identifiable manner, that the user will be induced to select a particular product.

The display itself is simplified by the fact that some attributes will be of more interest or value to the user than others for comparison, and consequently only those attributes need be displayed.

The display occurs simultaneously on several pages (FIGS. 3, 4, 5), tabs (6) for which are at all times in view. On first access to the database, all products and their associated attributes are in view (vertical scrolling or tab access to other pages lying just beneath the first) in a spreadsheet format display. The attributes which have been selected for display by the owner of the database appear as columnar fields (11), with the attribute name (12) at the head of the column. Within the columnar field for each attribute name are displayed all the numeric, alphanumeric, or text values existing in the database for that attribute. A given value may appear once or more than once. The values are displayed in horizontal rows associated with each individual product existing within the database. The total number of records displayed (number of attributes multiplied by number of products) may easily run into the thousands.

In the present invention, the user can refine his search to only those products whose attribute values match those of interest in the following manner:

The user navigates through the hierarchy via the commonly used “point and click” computer technology until he has selected the product type of interest to him. Having arrived at the list of products specific to his needs, he then uses the checkboxes in the display to select products of interest from among those products with their associated key parameter values available for display. This is accomplished by the user moving the cursor until it makes contact with the checkbox, and clicking the mouse button. When a product has been selected, the checkbox will change color, and a checkmark will appear in it (13), to signify that a selection has been made. The same action can be repeated to deselect any checked box, which will then revert to its original neutral color (16) to signify that the product is no longer selected (FIG. 9). Note that the term “checkbox” as used here is intended to be general in nature.

The user may select one or more products in this manner from among those appearing on one or more pages. When he has selected all the products he wishes, he clicks on the “Refine Search” (14) button on any page, and the program reduces the display list to only those products which have been selected (FIGS. 6, 7, 8). The attribute values associated with the selected products will continue to be displayed in horizontal rows aligned with the selected products. In this manner he is presented with a short list of all products within the database for that Product Type which are of interest. Any product selection may be eliminated at any time clicking on the checkbox for the selected at the left of the display page (FIGS. 9, 10). The search may be thus endlessly refined, including, if desired, to the original display of all attribute values for all products existing within the database. This may be accomplished by the user clicking the “Show All” button (15), which restores all of the products and their associated values to the display (FIG. 11). Note that the term “Refine Search” describes a process which may be alternately identified by the term “Filter” or other similar terms.

The selection of any product on any page exists entirely independent of the selections of products on any other pages. In this way the selection may be made for any unlimited number of products without reference to any other products. The refined search will include only those products which have been selected, regardless of the page in which those products appear. The number indicating the quantity of products for the type will change to reflect the quantity of products remaining in the refined search (17).

The display itself is simplified by the fact that some attributes will be of more interest or value to the User than others for comparison, and consequently only those attributes need be displayed. The User may then select one or more products based on his review of values from the dropdown list for one or more attributes on one or more pages. When used in its preferred embodiment in conjunction with the World.info website database and search process referenced in II above, it enables the user to select by using checkboxes which products of a given type will match the particular combination of attribute values he is seeking.

The invention works within the context of a software database created in such a manner as to prepare the data in a particular manner for selection and display. In the universe of all products existing within the database, each individual product is assumed to fall within the field of one or more Product Types. All products of a like kind, which share a sufficient number of specific attributes, such as function, performance levels, size, power requirements, and the like, are considered to comprise a type. In a very simple example, a sedan, an SUV, and a convertible may all be considered as examples of “Automobile” as a product type. Motorcycles and pickup trucks are all vehicles with attributes including rubber tires and internal combustion engines, but they are sufficiently different from automobiles and each other as to merit separate Product Types. Various attributes which are shared by all automobiles, by which a buyer (or User) might select a car, might include horsepower, headroom, safety features, warranty, or the like. Various products which fall within this product type include Chevy Malibu. Ford Explorer, Chrysler LeBaron. The database software is programmed to receive and catalogue data relating to products with their attributes and associated values for each attribute within discrete databases for each product type.

Product data may be provided by the manufacturer or seller, or derived from any other source, and entered into the database by means of a data entry mechanism to be protected by a subsequent patent. Data is entered manually, semiautomatically, or automatically into the database for display within the context of the World.info database and website (© World.info 2004; PPAs and RPAs relating to organization, search, and display methods referenced in II above and other patent applications yet to be submitted). Any new Product that is entered is immediately placed into its proper product type database(s) for ease of retrieval. Whenever a new product, service, or other item is entered into the database, the values for key parameters associated with that product are entered into the database by either manual, semiautomatic, or fully automatic method to be the subject of a future PTO application.

Eighteen (not limited to 18) fields of key parameters or attributes are chosen for display using our variable field name display (IID and IIE above). One to 5 (not limited to 5) layouts are created in which headings are not fixed but are themselves variable values, whose value is associated with each record and is fixed for that Product Type (not limited to Type). By making the field heading a variable associated with products of same kind (apples to apples), parametric headings of interest (hereafter identified as “key parameters’) can be determined and entered into the variable fields for those specific products or services, in groupings or associations. Such key parameters may be grouped together on single pages focused on, for instance, performance specifications, hardware specifications, or purchase information, for a given product. There is no limit to the number or type of such associations or groupings that may be created.

Our variable parameter feature (IIF and IIG above) recognizes that the purchaser of a given product is most interested in a relatively small number of attributes, a few key parameters, which are most likely to influence his decision as to which one of a number of products he will ultimately select. For instance, to the typical car buyer, mileage, engine size, roominess and color are of greater importance to him than what rim size, radio manufacturer, turn signal location or window tinting. He will seek out cars that meet the requirements that are his key parameters, before narrowing his search along other, less important, parameters. When used with the Fennell Hierarchy (IIA and IIB above) established in our preceding patent applications, the end-user is given instant access to an “apples-to-apples” comparison of products by specific key or most important attributes, while avoiding the confusion resulting in a search in which all conceivable attributes are listed. Once his search has been narrowed to a manageable size, he can proceed to sort by other, less important, attributes and their associated values.

The display occurs simultaneously on several pages, tabs for which are at all times in view. On first access to the database, all products and their associated attributes are in view (vertical scrolling or tab access to other pages lying just beneath the first) in a spreadsheet format display. The attributes which have been selected for display by the owner of the database appear as columns, with the Attribute Name at the head of the column. The values are displayed in horizontal rows associated with each individual product existing within the database. The total number of records displayed (number of attributes multiplied by number of products) may easily run into the thousands.

The invention can be used over the internet and will be accessible to end users who have personal computers with internet access. In this format, the end user will not require database software to be installed to access the data.

An important part of this patent is the generic quality of the attribute value grouping by which the products are displayed, so that it is universally adaptable to any type of information, commercial or non-commercial, which lends itself to User-selection according to preferred combinations of values. This patent is intended to include other generic names for parameters, attributes, or specifications groupings. The values for these attributes may be displayed in text, alphanumeric, or numeric forms.

The use of the term “product” as used in this patent application, while generally most useful in the marketplace arena to which the invention is primarily directed, is not intended to limit the scope of the invention to products only. The term “product” is construed to apply to any conceivable marketable item, object, service, performance, or idea. For example, its use includes, but is not limited to, such diverse items as the following: industrial or consumer products, fish ponds, county fairs, travel information, government contracts, international trade opportunities. The use of the checkboxes of the present application and associated search mechanisms (referenced in the PPAs given in II above and others yet to be filed) may, within the scope of this patent application, be extended to other, noncommercial uses. The term “Parameter” as used in this application may be also variously defined as “asset,” “attribute,”“capacity,” “specification,” “value,” or “property.” This patent is intended to protect the business method of the use of the System and Method for filtering Data Search by Utilizing User Selected Checkboxes as described herein. Specific algorithms and programming language to enable the processing of this method will be filed in subsequent patents applications.

The Figures showing the current configuration of the World.info website layouts are purely illustrative of its capacities, and may be altered in configuration and appearance without departing from the spirit and scope of the current invention. Note, for example, that the “Refine Search” (14) and “Show All” (15) buttons are illustrated in more than one location in FIGS. 6, 7, 8, 9, 10. Note that the illustration of buttons or fields in a particular places, or the horizontal or vertical alignment of data, is intended to be generic in nature, and that the present application is intended to protect functional relationships of the data and the dynamic features of the checkbox refined search.

While our invention and its immediate most commercial viability concerns itself with variable parameter fields for product types, this method of organization is not considered to be limited to parameter fields for product types only but extends, under this provisional patent application, to all categories of hierarchical data entry and display, Note that, while the user-selection by checkboxes is conceived as a function within the variable field names used in conjunction with the Fennell Hierarchy and associated PPAs referenced in II above, the use of this invention is not restricted to these systems and methods, but may be broadly applied in other unspecified search and display mechanisms. The reader will see that the extreme versatility of this method in describing any conceivable product, item, or service in terms of a few key parameters by which all similar items may be compared. The description contained within Section VII is not to be construed as limiting the scope of the invention, but rather as an exemplification of one preferred embodiment thereof.

Other possible embodiments include, but are not limited to:
1. The use of the user-selection by checkbox process described above in other search mechanisms than that of the Fennell Hierarchy and its associated components referenced in II above, whether currently existing or yet to be devised.
2. The use of the user-selection by checkbox process described above as a component of the Fennell Hierarchy and its associated search mechanisms referenced in II above, used within a privately held database, with limited access through a local server.
3. The use of the user-selection by checkbox process described above, used over the internet within existing commercial and noncommercial databases.
4. Many other variations are possible, for example the description or definition of travel and entertainment opportunities, real estate, catalogs of all kinds commercial and noncommercial. Accordingly, the scope of the invention should not be determined solely by the embodiments listed above, but by the appended claims and their legal equivalents.

Unique systems and methods of navigation and display will be filed in subsequent patents.

1. A method of retrieving and displaying stored data of any kind, comprising:
a. a computer terminal connected to the internet,
b. a storage means for storing data on a digital or electronic storage medium,
c. an algorithmic logic circuit configured to prepare the storage medium to store the data,
d. an algorithmic logic circuit for locating the stored data,
e. an algorithmic logic circuit by which the stored data may be associated with one or more field names or headings,
f. an algorithmic logic circuit for retrieval and display of located data in a user-manipulated spreadsheet display in a single- or multiple-page layout in which the records are named or described by the field heading under which they exist
g. an algorithmic logic circuit enabling user-selection of specific records in the located data,
h. an algorithmic logic circuit enabling the simultaneous selection and display of all examples sharing all of the combined user-selected records for all the fields existing in the stored data
whereby specific data or combinations of specific data for a given item may be compared with like data or combinations of specific data for other items of a like kind according to user-selection, by means of checkboxes identified with specific fields, each with its own associated data records.

2. The use of the method of claim #1 above of retrieving and displaying stored data of any kind, as a business method for enabling the user to locate, review, and compare product information, by which he can select any number of products for further review.

3. A system for organizing, processing, locating, and displaying products along with their associated data, including the user-selection capability of the specification above, comprising:
a. a computer terminal connected to the internet,
b. a storage means for storing data on a digital or electronic storage medium,
c. an algorithmic logic circuit configured to prepare the storage medium to store the data,
d. an algorithmic logic circuit for locating the stored product and product specification data,
e. an algorithmic logic circuit by which the stored data may be associated with one or more field names or headings,
f. an algorithmic logic circuit for retrieval and display of located data in a user-manipulated spreadsheet display in a single- or multiple-page layout in which the records are named or described by the field heading under which they exist
g. an algorithmic logic circuit enabling user-selection of specific records in the located data,
h. an algorithmic logic circuit enabling the simultaneous selection and display of all examples sharing all of the combined user-selected records for all the fields existing in the stored data
whereby specific data or combinations of specific data for a given item may be compared with like data or combinations of specific data for other items of a like kind according to user-selection, by means of checkboxes identified with specific fields, each with its own associated data records.

4. The data processing system of claim #3 further used as a business method as a means for enabling the user to retrieve, review and compare for selection, and if desired, purchase products of a like kind, by displaying only those of the products being considered that are of interest to the user while bypassing those which are not germane to the application.

5. The data processing system of claim #3 further used as a means of storing unlimited amounts of data for unlimited types of products and displaying it in unlimited combinations of user-selected preferences.

6. The data processing system of claim #3 further used as a component of internet navigation systems other than those covered by patents owned or claimed by World.info, as a means for enabling the user to retrieve, review and compare for purchase specific products of a like kind.

7. The algorithmic logic programming language enabling all of the logic circuits of claim #3 as a means for enabling of the data processing system described in claim #3 above.
